(19) United States
(12) Patent Application Publication
(10) Pub. No.: US 2006/0057262 A1
(43) Pub. Date: Mar. 16, 2006

(54) Process for extracting oil from articles

(76) Inventors: James R. Diefenthal JR., Chapel Hill, NC (US); Chirag N. Nanavati, Chapel Hill, NC (US); Daniel T. Bowman, Durham, NC (US)

Correspondence Address: DAVID P. HENDRICKS;LAW OFFICE OF DAVID P. HENDRICKS, PO BOX 37127, RALEIGH, NC, 27627, US

(21) Appl. No.: 10/941,460

(22) Filed: Sep. 15, 2004

(51) Int. Cl. A23C 15/14

(52) U.S. Cl. 426/417

(57) ABSTRACT

A process for reducing the oil content of oil-containing articles, such as food products. The food products are placed in contact with subcritical liquid carbon dioxide for a period of time sufficient to extract a predetermined amount of oil. The predetermined amount of oil to be extracted is within the range of about 5 percent to about 90 percent of the original oil content of the oil-containing article, in addition ranging from about 5 percent to about 75 percent of the original oil content of the oil-containing article, and further in addition ranging from about 5 percent to about 50 percent of the original oil content of the oil-containing article. The extracted oil optionally may be separated from the liquid carbon dioxide. The separated oil may be reused in the manufacture or processing of the oil-containing article, and the separated liquid carbon dioxide may be reused in the extraction process.

### TECHNICAL FIELD

The present invention relates generally to a process to extract oil from oil-containing articles and more specifically to extracting oil from food products.

### BACKGROUND

On any given day, a large potion of the population of the United States is on some type of diet. Each year, an estimated 50 million people will start a diet. Dieting has become so pervasive in America that it has become a part of the common culture. While diet programs tout almost everything from rice to grapefruit as their weight loss secret, the key to any legitimate diet program is to reduce daily caloric intake and increase the amount of calories the body burns for energy. In order to reduce caloric intake, most dieters eliminate high calorie foods from their diet. Often, the foods eliminated are flour-based bakery goods such as breads, doughnuts, and pastries.

Flour-based bakery products are the bane of dieters because of their often high fat content. The source of the fat may be frying oil, such as that used to cook doughnuts, or oil or lard added as an ingredient, such as recipes for flaky bakery products like croissants. Because of the high fat content of these products, most dieters are forced to avoid eating them. This is problematic, however, because these are often the foods that the dieter craves and desires the most due to their flavorfulness, or because of their widespread use like bread products. Thus, it is very difficult for dieters to avoid flour-based bakery products altogether. Consequently, a need exists for reduced oil content flour-based bakery products.

Flour-based bakery products that are cooked in oil may have an oil content of about 10 percent to about 40 percent by weight. Due to this high oil content, bakery product manufacturers have repeatedly attempted to manufacture these products with a lower oil content so that dieters can still consume these products while attempting to reduce caloric intake. Examples of these past attempts include U.S. Pat. No. 6,001,399 that claims the substitution of polydextrose for sugar reduces oil absorption during the frying process. The injection of polyvinylpyrrolidone into the pastry batter to reduce fat content is claimed in U.S. Pat. No. 4,937,086. An article published by the United States Department of Agriculture in the Journal of Food Science in 2001 entitled “Development of Low Oil-Uptake Donuts” discussed substituting rice flour for wheat flour in a doughnut recipe to lower fat content. This method was based on technology described in U.S. Pat. No. 6,224,921.

Other methods have been developed to remove a portion of the oil from the cooked product. A method using liquid carbon dioxide as the medium to remove the oil from the end product is claimed in U.S. Pat. No. 5,312,635. However, due to the high pressure at which this method operates and the characteristics of the liquid carbon dioxide flow, it is limited to non-flour-based products such as potato chips and corn chips. Similarly, liquid carbon dioxide has been used to remove oil from peanuts as claimed in U.S. Pat. No. 5,290,578.

There currently exists no method to successfully remove oil from flour-based bakery products. Due to the soft texture and lack of structural rigidity of flour-based bakery products, current methods to reduce the oil content, such as that used for potato chips, corn chips, and peanuts, cannot be used for such products.

A need exists, therefore, for a process to extract oil from oil-bearing flour-based bakery products. A need also exists for a process to extract oil from oil-bearing flour-based bakery products that results in products that are comparable in taste, appearance, and texture to conventional flour-based bakery products. A further need exists for such a process which does not necessitate a change in the recipe of the flour-based bakery product. A further need exists for reduced oil content flour-based bakery products produced according to such a process.

### SUMMARY

The present invention is directed to a process and articles that satisfy these needs. The invention is based on the ability of liquid carbon dioxide that is below the critical temperature and critical pressure (subcritical) to act as a solvent. The liquid carbon dioxide is used to remove a portion of the oil from oil-containing articles such as flour-based bakery products, yet still retain the desirable taste, appearance, and texture of the original oil-containing articles.

One aspect of the invention features a process to extract oil from oil-containing articles. One or more articles are first provided at a temperature below ambient temperature, then placed into an extraction chamber. The extraction chamber is then filled with essentially oil-free liquid carbon dioxide using a diffusing means. The essentially oil-free liquid carbon dioxide is contacted with the oil-containing articles for a period of time sufficient to extract a predetermined amount of oil from the oil-containing articles to produce reduced oil content articles and oil-bearing liquid carbon dioxide. The oil-bearing liquid carbon dioxide is then withdrawn from the chamber and the oil is separated from the liquid carbon dioxide.

Another aspect of the invention features providing the oil-containing article at a temperature less than about 10° C., and still another aspect of the invention features providing the oil-containing article at a temperature sufficient to freeze the article. Yet another aspect of the invention features maintaining the temperature of the liquid carbon dioxide in the extraction chamber at a temperature ranging from about 0° C. to about 30° C. Still another aspect of the invention features maintaining the pressure of the liquid carbon dioxide in the extraction chamber at a pressure about above the liquifaction pressure, ranging from about the liquifaction pressure to about 4,500 psig.

Yet another aspect of the invention features contacting the oil-containing article and the liquid carbon dioxide in the extraction chamber for a period of time sufficient to reduce the oil content of the oil-containing article from about 5 percent to about 90 percent of the original oil content of the oil-containing article, in addition from about 5 percent to about 75 percent of the original oil content of the oil-containing article, and further in addition from about 5 percent to about 50 percent of the original oil content of the oil-containing article. Still another aspect of the invention features repeating a plurality of times the steps of contacting the oil-containing article with the essentially oil-free liquid carbon dioxide and withdrawing the oil-laden carbon dioxide from the extraction chamber.

Yet another aspect of the invention features reducing the pressure of the oil-laden liquid carbon dioxide withdrawn from the extraction chamber to below the liquifaction pressure whereby the liquid carbon dioxide vaporizes, producing oil in a separate liquid phase and essentially oil-free carbon dioxide in a separate gas phase. Still another aspect of the invention features increasing the pressure of the essentially oil-free carbon dioxide in a separate gas phase to about above the liquifaction pressure, producing essentially oil-free liquid carbon dioxide. Still another aspect of the invention features using the essentially oil-free liquid carbon dioxide produced by the previously described step as the essentially oil-free liquid carbon dioxide that is contacted with the oil-containing article.

Still another aspect of the invention features using food products as the oil-containing article, and yet another aspect of the invention features using flour-based bakery products as the food products.

These and other features, aspects, and advantages of the present invention will become better understood with reference to the following description and appended claims.

### DEFINITIONS

In the description that follows, a number of terms are used. In order to provide a clear and consistent understanding of the specification and appended claims, including the scope to be given such terms, the following definitions are provided:

Ambient Conditions. Ambient conditions means a temperature of about 32° C. and a pressure of about 1 atmosphere (14.7 psia).

Flour-Based Bakery Products. Because such a large number of diverse products can be classified as flour-based bakery products, it is not possible to provide a complete list of every such product for which the present invention has utility. Therefore, because these products are typically manufactured for commerce, industrial classification codes developed by the U.S. Census Bureau can be used to describe, in general, the types of products understood to be flour-based bakery products. The following table presents North American Industry Classification System (NAICS) codes for commercial facilities that either produce or sell what is typically construed as flour-based bakery products. The table is not meant to be limiting; rather, it is intended to convey a general sense of the type of product envisioned by the use of the term, flour-based bakery product.

North American Industry Classification Codes and
Associated Products For Flour-Based Bakery Products^{a}

| NAICS Code | Associated Flour-Based Bakery Products |
|---|---|
| 311812 | Bagels, Bread, Cakes, Doughnuts, Pastries, Biscuits, Rolls, |
| | Wafers, Croissants, Croutons, Bread Crumbs, Crullers, |
| | Knishes, Matzo, Danishes, Pies, Pretzels, Buns, |
| | Sweet Yeast Goods, Unleavened Bread |
| 311813 | Cakes, Crullers, Bakery Desserts, Doughnuts, Knishes, |
| | Pastries, Pies, Sweet Yeast Goods |
| 311821 | Biscuits, Cookies, Crackers, Ice Cream Cones |
| 311822 | Batter, Bread, Rolls, Cookie Dough, Dough, Pastries, |
| | Pie Crust Shells, Pizza Dough |
| 311823 | Pasta, Egg Noodles, Macaroni, Spaghetti |
| 311830 | Tortillas |
| 722213 | Bagels, Cookies, Doughnuts, Pretzels |

^{a}Source: http://www.census.gov/epcd/naics02

Subcritical Carbon Dioxide. Carbon dioxide at a temperature below the critical temperature of 31.1° C. or below the critical pressure of 1,070.6 psia is subcritical. Subcritical carbon dioxide can exist as either a gas or a liquid. If the pressure is maintained above the liquifaction pressure at a given temperature, the subcritical carbon dioxide will be a liquid; otherwise, it will be a gas.

Supercritical Carbon Dioxide. Carbon dioxide that is maintained at a temperature above the critical temperature of 31.1° C. and the critical pressure of 1.070.6 psia is known as supercritical carbon dioxide. Materials in the supercritical range lose the distinction between liquid as solid states and show properties of both liquids and gases.

### DETAILED DESCRIPTION

It is understood that the embodiments described herein are intended to serve as illustrative examples of certain embodiments, including the preferred embodiment, of the present invention. Other arrangements, variations, and modifications of the described embodiments of the invention may be made by those skilled in the art. No unnecessary limitations are to be understood from the disclosure, and any arrangements, variations, and modifications may be made without departing from the spirit of the invention and scope of the appended claims. Stated ranges include end points of the range and all intermediate points within the end points.

Carbon dioxide is a non-flammable, colorless, and odorless substance which exists as a gas at ambient conditions. Carbon dioxide may exist simultaneously as a solid, liquid, and gas at a temperature of −56.6° C. and a pressure of 60.4 psig (the triple point). By varying the temperature and pressure within certain ranges, the carbon dioxide can exists entirely as a gas, liquid, or solid. However, once the temperature and pressure reach the critical point, a supercritical fluid is formed. Under these conditions the distinction between gases and liquids does not apply and the substance can only be described as a fluid. The critical temperature for carbon dioxide is 31.1° C., and the critical pressure is 1,070.6 psia. Above these values, carbon dioxide behaves as a supercritical fluid and shows properties of both a liquid and a gas.

Supercritical carbon dioxide is a versatile non-polar solvent for many organic compounds. By adjusting the pressure of the fluid, the solvent properties can be varied to more closely resemble gaseous substances or liquid substances. Thus, the solvent properties can be fine-tuned by varying the pressure.

Carbon dioxide can be liquefied at any temperature between the triple point temperature of −56.6° C. and the critical point temperature of 31.1° C. by compressing the carbon dioxide to the liquefaction pressure at the selected temperature without achieving a supercritical state. This subcritical liquid carbon dioxide possesses solvent properties similar to supercritical carbon dioxide. Specifically, liquid carbon dioxide has been found to be effective in extracting oil from oil-containing articles.

The present invention takes advantage of the solvent properties of subcritical liquid carbon dioxide to extract oil from flour-based bakery products. In general, a process according to the present invention includes placing flour-based bakery products into an extraction chamber. The extraction chamber is then closed and filled with subcritical liquid carbon dioxide. The liquid carbon dioxide is allowed to contact the flour-based bakery products for a period of time sufficient to extract a predetermined amount of oil from the flour-based bakery products. This process yields flour-based bakery products with reduced oil content and oil-laden liquid carbon dioxide. The oil-laden liquid carbon dioxide can be further processed by separating the oil from the liquid carbon dioxide.

During the extraction process, the liquid carbon dioxide is maintained at a temperature in the range of about 0° C. to about 30° C. Typically, the operating range is from about 5° C. to about 20° C. The pressure of the liquid carbon dioxide may vary and is dependent on the temperature of the liquid carbon dioxide. The pressure must be maintained above about the liquifaction pressure of the carbon dioxide at a given operating temperature. Generally, the pressure ranges from above about the liquifaction pressure to about 4,500 psig. The typical operating range is from about the liquifaction pressure to about 1,500 psig.

Flour-based bakery products typically have an oil content of between about 10 percent and about 40 percent by weight. Nearly any amount of the oil in the flour-based bakery products can be extracted by the process of the invention. The amount of oil extracted by the process of the invention can be easily controlled by varying the carbon dioxide flow rate and the extraction time. These parameters may be chosen based upon the initial oil content of the flour-based bakery products, the desired final oil content of the flour-based bakery products, and the nature of the flour-based bakery products. For instance, cake doughnuts are denser and have a smaller surface area to volume ratio than glazed doughnuts, and accordingly require increased extraction time to obtain a given degree of oil removal, all other parameters of the process being equal.

Several factors may impose practical limitations on the amount of oil extracted using the process of the invention. The total volume of liquid carbon dioxide in the extraction chamber determines the amount of oil that can be solubilized before saturation is reached an no further oil extraction will occur. Additionally, the amount of time for the liquid carbon dioxide to penetrate to the oil located near the center of the flour-based bakery products may not be practical in a commercial setting. Therefore, while the original oil content can be reduced to about 5 percent or less of its original value by extended processing times, generally the original oil content is reduced to about 5 percent to about 90 percent of its original value, and typically about 5 percent to about 75 percent of its original value, or even about 5 percent to about 50 percent of its original value.

The oil can be separated from the liquid carbon dioxide by reducing the pressure to below the liquifaction pressure at a given temperature. Once the pressure falls below this value, the liquid carbon dioxide will vaporize and the oil will remain in a liquid phase. The carbon dioxide can be captured and reused in the process as essentially oil-free liquid carbon dioxide. The recovered oil is suitable for reuse in the cooking process of the flour-based bakery products.

Any conventional equipment known in the art can be used for the separation process. The separation may occur in a batch mode or continuously during the extraction process. In a batch mode, the liquid carbon dioxide is contacted with the oil-containing articles until the liquid carbon dioxide becomes saturated or the desired extent of oil removal is achieved. The oil-laden liquid carbon dioxide is then removed from the extraction chamber and into a second chamber. The second chamber is designed such that the temperature and pressure of the oil-laden liquid carbon dioxide can be controlled. When the temperature of the oil-laden liquid carbon dioxide is increased or the pressure is decreased, the liquid carbon dioxide will reach a state where it is no longer capable of retaining the dissolved oil. The dissolved oil will then separate from the liquid carbon dioxide and fall to the bottom of the chamber, while the less dense essentially oil-free carbon dioxide moves to the top of the chamber. At this point, the oil can be removed from the chamber through an airlock and is suitable for reuse in the manufacture or processing of the flour-based bakery products. The essentially oil-free carbon dioxide is then recompressed to liquify any gaseous carbon dioxide that formed during the separation procedure and can be reused in the extraction process.

In a continuous separation process, a portion of the oil-laden liquid carbon dioxide is continuously removed from the extraction chamber, vaporized by reducing the pressure to below the liquifaction pressure, capturing the gaseous carbon dioxide and repressurizing to above the liquifaction pressure to produce essentially oil-free liquid carbon dioxide, and returning the essentially oil-free liquid carbon dioxide to the extraction chamber in a closed loop.

The ability to control the amount of oil extracted from flour-based bakery products is a feature of this invention. As consumer tastes and market regulations evolve, it may become more desirable to produce a healthier very low oil content product with less desirable taste, or a less healthy product with a higher oil content and more desirable taste characteristics, or both.

Liquid carbon dioxide has been demonstrated to extract oil from certain food products. These food products include nuts, potato chips, corn chips, and coffee beans. A common characteristic of these food products is their relative hardness and structural rigidity, which allows them to withstand very high pressures and direct contact with the liquid carbon dioxide flow within the extraction chamber. Flour-based bakery products, however, have a soft texture and less structural integrity. Due to the more delicate nature of flour-based bakery products, several of the process parameters must be tightly controlled.

First, because flour-based bakery products are softer than peanuts, chips, or coffee beans, liquid carbon dioxide pressures above about 1,500 psig tend to damage the structural integrity of the flour-based bakery products. This is unacceptable because consumers will not purchase flour-based bakery products with obvious structural defects (e.g., a doughnut broken into pieces).

Second, because lower liquid carbon dioxide pressures are required, the temperature of the liquid carbon dioxide must be reduced in order to maintain the carbon dioxide in a liquid state. Flour-based bakery products may reach temperatures approaching 200° C. or more in the cooking process. Placing hot flour-based bakery products in the extraction chamber would have the tendency to vaporize the liquid carbon dioxide and require excessive cooling capabilities and unacceptably long extraction times. To overcome this problem, the cooked flour-based bakery products are pre-cooled to a temperature below about 30° C. before placing them into the extraction chamber. In general, the flour-based bakery products can be pre-cooled to a temperature in the range of about 0° C. to about 30° C., and the typical operating range is about 5° C. to about 20° C. The flour-based bakery products may also be cooled to a frozen state. Pre-cooling the flour-based bakery products has the additional advantage of increasing their structural rigidity; thus, they are less likely to be damaged during the extraction process.

Third, the soft texture and low structural integrity of flour-based bakery products dictate that the liquid carbon dioxide be introduced into the extraction chamber in a more gentle manner compared to other food products. The use of a diffuser at the chamber inlet prevents the liquid carbon dioxide from impacting the surface of the flour-based bakery products with enough force to affect the structural integrity of the flour-based bakery products.

The following examples are provided to further illustrate the present invention. The examples are not intended to limit the scope of the present invention and should not be so interpreted.

### EXAMPLE 1

A 108.2 gram sample consisting of two cake-type doughnuts with approximately 23 percent oil content by weight was placed in a cage inside a 5 liter extraction chamber after being removed from a refrigerator and weighed. Once the chamber was sealed, air was purged through the slow introduction of gaseous carbon dioxide. Liquid carbon dioxide was then introduced to the chamber through a diffuser device to prevent damaging the delicate doughnuts. The pressure in the chamber was brought up to about 1,000 psig through the use of a small air diaphragm type pump. Once the working pressure was reached, the liquid carbon dioxide was circulated through a small loop using the pump. The circulating liquid carbon dioxide was passed through a heat exchanger which helped to cool the liquid carbon dioxide to the working temperature. Once the temperature of the contents of the chamber reached the working temperature of about 10° C. the liquid carbon dioxide was circulated for an additional 30 minutes. The temperature was maintained at about 10° C., and small amounts of carbon dioxide were added from time to time to maintain the working pressure in the extraction chamber.

After about 30 minutes, the oil-laden liquid carbon dioxide was removed from the chamber and essentially oil-free liquid carbon dioxide was introduced into the chamber. The circulation process described above was repeated and after the second batch of oil-laden liquid carbon dioxide was withdrawn from the chamber, the doughnuts were removed and reweighed to determine how much oil was removed.

When the samples were removed from the chamber and weighed, they showed a reduction in weight of 6.5 gram. The samples had an oil content of 24.7 grams before the experiment, so there was an approximate 26 percent reduction in oil content resulting in a finished product that had about 18 percent oil content by weight.

### EXAMPLE 2

In this example, a 132.4 gram sample of four glazed doughnuts containing approximately 23 percent oil by weight was placed in the basket of the extraction chamber after being removed from a refrigerator and weighed. The experiment was carried out using the same machine following the same procedures as described in Example 1. While treating this sample, oil-laden liquid carbon dioxide was replaced with essentially oil-free liquid carbon dioxide three times. Each time the carbon dioxide was circulated in the chamber for about 30 minutes after the working temperature and working pressure were reached.

When the samples were removed from the chamber and weighed, they showed a reduction in weight of 16.1 grams. The samples had an oil content of 30.4 grams before the experiment, so there was about a 53 percent reduction in oil content resulting in a final product that had 12 percent oil content by weight.

### EXAMPLE 3

In this example a 24.4 gram doughnut sample containing approximately 23 percent oil by weight was placed in the basket of the extraction chamber after being removed from a refrigerator and weighed. The experiment was carried out using the same machine and following the same procedures as described in Example 1. The sample was exposed to liquid carbon dioxide at a temperature of 10° C. and a pressure of 1000 psig. The sample was exposed to the liquid carbon dioxide for a period of approximately 20 minutes. The shorter extraction time for this example was due to the smaller sample size as compared to Examples 1 and 2.

After treatment, the sample was removed from the chamber and it weighed 20.0 grams. The sample had an initial oil content of 5.6 grams, indicating that there was about a 79 percent reduction in oil. The final product had an oil content of 6 percent of the total weight.

### COMPARATIVE EXAMPLE

In this example, a 48 gram doughnut sample was placed into the extraction chamber after being removed from a refrigerator and weighed. The experiment was carried out using the same machine and following the same procedures as described in Example 1, with the exception that the diffuser for the liquid carbon dioxide inlet was removed. The sample was exposed to a temperature of 12° C. and a pressure of 1000 psig for 15 minutes. Upon opening the chamber it was discovered that the structural integrity of the doughnut was destroyed, reducing the doughnut to small, broken particles. The ending weight could not be determined with any degree of accuracy; hence, it was not measured.

We claim:

1. A process for extracting oil from oil-containing articles comprising the steps of:
a. providing an oil-containing article at a temperature below ambient temperature;
b. placing the article into an extraction chamber;
c. filling the extraction chamber with essentially oil-free liquid carbon dioxide using a diffusing means;
d. contacting the oil-containing article with the essentially oil-free liquid carbon dioxide in the extraction chamber for a period of time sufficient to extract a predetermined amount of oil from the oil-containing article resulting in a reduced oil content article and oil-bearing liquid carbon dioxide;
e. withdrawing the oil-bearing liquid carbon dioxide from the extraction chamber; and
f. separating the oil from the liquid carbon dioxide.

2. The process of claim 1 wherein the temperature of the oil-containing article is less than about 10° C.

3. The process of claim 1 wherein the temperature of the oil-containing article is sufficient to freeze the article.

4. The process of claim 1 wherein the oil-containing article is a food product.

5. The process of claim 4 wherein the food product is flour-based bakery products.

6. The process of claim 1 wherein the liquid carbon dioxide is maintained in the extraction chamber at a temperature ranging from about 0° C. to about 30° C., in addition ranging from about 5° C. to about 20° C.

7. The process of claim 6 wherein the liquid carbon dioxide is maintained in the extraction chamber at a pressure above the liquefaction pressure, in addition ranging from about above the liquefaction pressure to about 4,500 psig, and further in addition ranging from about above the liquefaction pressure to about 1,500 psig.

8. The process of claim 1 wherein the period of time is sufficient to reduce the oil content of the oil-containing product from about 5 percent to about 90 percent of the original oil content of the oil-containing product, in addition from about 5 percent to about 75 percent of the original oil content of the oil-containing product, and further in addition from about 5 percent to about 50 percent of the original oil content of the oil-containing product.

9. The process of claim 1 further comprising reducing the pressure of the oil-bearing liquid carbon dioxide withdrawn from the extraction chamber to below the liquefaction pressure whereby the liquid carbon dioxide at least partially vaporizes, producing a separate oil phase and a separate essentially oil-free carbon dioxide phase.

10. The process of claim 9 further comprising increasing the pressure of the essentially oil-free carbon dioxide to about above the liquifaction pressure, producing essentially oil-free liquid carbon dioxide.

11. The process of claim 1 further comprising repeating steps (d) and (e) a plurality of times using essentially oil-free liquid carbon dioxide for each repetition of the steps.

12. The process of claim 11 wherein the essentially oil-free liquid carbon dioxide is obtained by reducing the pressure of the oil-bearing liquid carbon dioxide withdrawn from the extraction chamber to below the liquefaction pressure whereby the liquid carbon dioxide at least partially vaporizes, producing a separate oil phase and a separate essentially oil-free carbon dioxide phase, then increasing the pressure of the essentially oil-free carbon dioxide to about above the liquifaction pressure, producing essentially oil-free liquid carbon dioxide.

13. A process to produce a reduced oil content product whereby an oil-containing product is exposed to liquid carbon dioxide at a temperature ranging from about 0° C. to about 30° C. and a pressure ranging from about above the liquefaction pressure to about 4,500 psig for a period of time sufficient to reduce the oil content of the oil-containing product from about 5 percent to about 50 percent of the original oil content of the oil-containing product.

14. A reduced oil content product produced in accordance with the method of claim 13.

15. The reduced oil content product of claim 14 being a flour-based bakery product.
